(19) United States
(12) Patent Application Publication
(10) Pub. No.: US 2022/0172230 A1
(43) Pub. Date: Jun. 2, 2022

(54) CONTINUOUS VALUE MONITOR

(71) Applicant: Cogito Corporation, Boston, MA (US)

(72) Inventor: Skyler Place, Boston, MA (US)

(73) Assignee: Cogito Corporation, Boston, MA (US)

(21) Appl. No.: 17/541,197

(22) Filed: Dec. 2, 2021

Related U.S. Application Data
(60) Provisional application No. 63/120,591, filed on Dec. 2, 2020.

(51) Int. Cl. G06Q 30/02

(52) U.S. Cl. CPC G06Q 30/0201

(57) ABSTRACT

A continuous value monitor system is disclosed in which large enterprise call centers can monitor the performance of a plurality of call agents by measuring the averages of performance and consistency of performance by using an audio behavioral analysis system and determining the variability of the call agents performance from changes in operational policies or workflows and converting the changes in performance to a dollar value to provide a report which displays the business outcomes of the changes in operational policy or workflows by providing a monetary value to the variability.

### FIELD OF THE DISCLOSURE

The present disclosure is generally related to the difference in behaviors and financial implications in call center environment when a change in workflow or policy is implemented.

### BACKGROUND

Currently, there is an issue with how large enterprise call centers understand potential operational changes to their employees and their employee's workflow processes, especially how the changes affect the enterprises profit and loss. Also, a current issue is how potential adjustments to policies and workflow process would impact their business outcomes. Lastly, it is difficult to provide objective and actionable data of how potential adjustments to policies and workflow process effect customer service and the customer experience when using a call center. There is a need in the art to provide a system to effectively monitor operational adjustments to provide enterprises with a continuous value monitoring system which informs enterprises of potential business outcomes based on operational adjustments.

### DESCRIPTIONS OF THE DRAWINGS

FIG. 1: Illustrates a Behavioral Analysis Measurement Platform.

FIG. 2: Illustrates a Platform Base Module.

FIG. 3: Illustrates a Platform Data Collection Module.

FIG. 4 Illustrates a Platform Data Analysis Module.

FIG. 5: Illustrates a Platform Results Module.

FIG. 6: Illustrates a Platform Recommendation Module.

FIG. 7: Illustrates a Client Network 1-N Event Module.

### DETAILED DESCRIPTION

Reference will now be made in detail to the various exemplary embodiments of the subject disclosure illustrated in the accompanying drawings. Wherever possible, the same or like reference numbers will be used throughout the drawings to refer to the same or like features. It should be noted that the drawings are in simplified form and are not drawn to precise scale. Certain terminology is used in the following description for convenience only and is not limiting. Additionally, the term “a,” as used in the specification, means “at least one.” The terminology includes the words above specifically mentioned, derivatives thereof, and words of similar import.

“About” as used herein when referring to a measurable value such as an amount, a temporal duration, and the like, is meant to encompass variations of ±20%, ±10%, ±5%, ±1%, or ±0.1% from the specified value, as such variations are appropriate.

“Substantially” as used herein shall mean considerable in extent, largely but not wholly that which is specified, or an appropriate variation therefrom as is acceptable within the field of art. “Exemplary” as used herein shall mean serving as an example.

Throughout this disclosure, various aspects of the subject disclosure can be presented in a range format. It should be understood that the description in range format is merely for convenience and brevity and should not be construed as an inflexible limitation on the scope of the subject disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Furthermore, the described features, advantages and characteristics of the exemplary embodiments of the subject disclosure may be combined in any suitable manner in one or more embodiments. One skilled in the relevant art will recognize, in light of the description herein, that the present disclosure can be practiced without one or more of the specific features or advantages of a particular exemplary embodiment. In other instances, additional features and advantages may be recognized in certain embodiments that may not be present in all exemplary embodiments of the subject disclosure.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

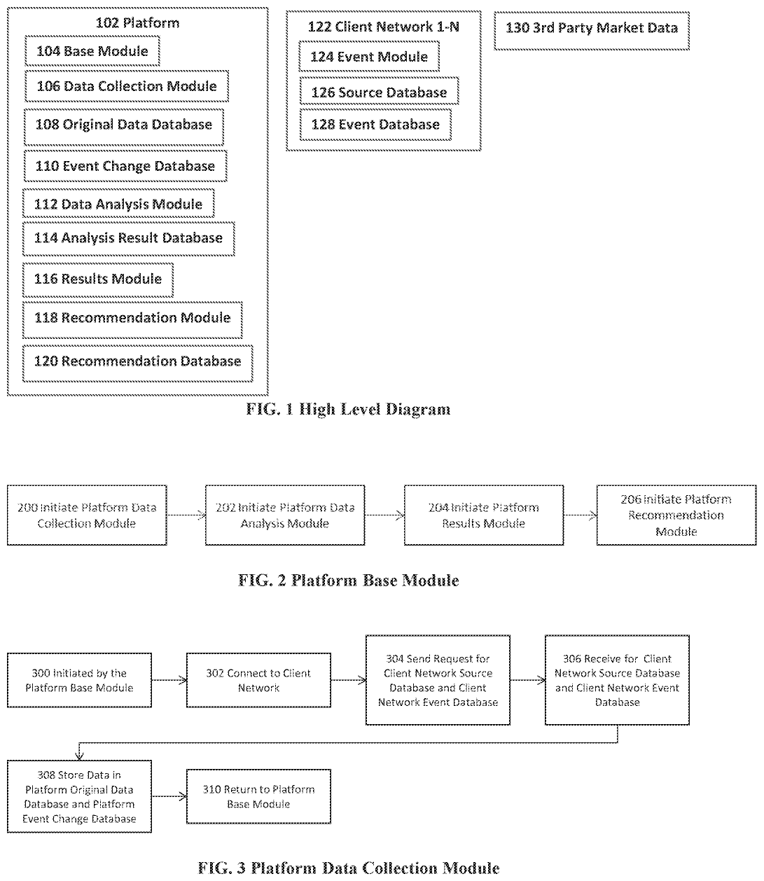

FIG. 1 is a system for a Behavioral Analysis Measurement Platform. This system comprises of the Platform 102 may be a server managed by a data (e.g., behavioral data (e.g., sensor and usage data)) analysis service provider, a scalable cloud environment, a hosted centralized onsite server, or the like. The Platform 102 may be communicatively coupled with other third party platforms, in order to provide or perform other services on the data (e.g., audio data). In turn, the Platform 102 processes (e.g., analyses) received data (e.g., audio data, sensor and/or usage data) from the Client Network 1-N 122 e.g., by executing a Platform Base Module 104, Platform Data Collection Module 106, Platform Data Analysis Module 112 and a Platform Results Module 116, and storing and/or extracting data from the Platform Original Data Database 108, Platform Event Change Database 110, Platform Analysis Results Database 114 element 102. The Platform Base Module 104 initiates the Platform Data Collection Module 106, the Platform Data Analysis Module 112 and the Platform Results Module 116, which allows the Platform 102 to collect the original data stored in the Client Network 1-N Source Database 126, the newly stored data after an event has occurred stored in the Client Network 1-N Event Database 128 through the Platform Data Collection Module 106, analyzes the data through the Platform Data Analysis Module 112, and prepares the results and sends the results to the client through the Platform Results Module 116, element 104. The Platform Data Collection Module 106, which is initiated through the Platform Base Module 104, connects to the Client Network 1-N 122 through the Client Network 1-N Event Module 124 and sends a request and receives the data stored in the Client Network 1-N Source Database 126 and the Client Network 1-N Event Database 128, and stores the data in the Platform Original Data Database 108 and the Platform Event Change Database 110, element 106. The Platform Original Data Database 108 contains the data stored in the Client Network 1-N Source Database 126 through the Platform Data Collection Module 106, and contains the client data prior to an event change, element 108. The Platform Event Change Database 110 contains the data stored in the Client Network 1-N Event Database 128 through the Platform Data Collection Module 106, and contains the client data after an event change, element 110. The Platform Data Analysis Module 112 compares the data stored in the Platform Original Data Database 108 and the Platform Event Change Database 110, the Platform Data Analysis Module 112 compares the behavioral analysis data of audio data stored in the Platform Original Data Database 108 and the Platform Event Change Database 110 to determine differences in consistency of performance, changes in average performance, customer experience, etc., stores the differences in the Platform Analysis Results Database 114 and provides the Client Network 1-N 122 with a continuous measurement of agent performances, element 112. The Platform Analysis Result Database 114 stores the data from the analysis performed during the Platform Data Analysis Module 112 and is used during the process described in the Platform Results Module 116, the database contains the average difference in performance metrics for each agent from the Client Network 1-N 118 from the Platform Original Data Database 108 to the Platform Event Change Database 110, element 114. The Platform Results Module 116 connects to 3rd Party Market Data 130 sites to receive market data relevant to the client's business, and compares the analysis completed by the Platform Data Analysis Module 112 to determine a profit or loss to the analysis by using the data in the Platform Analysis Results Database 114 with the received market data, for example if the received market data states that the average wage for an agent is $10 an hour and over the course of an 8 hour work day the agent fields 96 events or calls, an average of one call for every 5 minutes, the Platform Results Module 116 can use the averages determined from the Platform Analysis Result Database 114 and comparing the 3rd Party Market Data 130 to the Platform Analysis Result Database 114 to determine if the agents have a similar average, for example if the average event time for the data stored in the Platform Event Change Database 110 is 7 minutes then since the event change the agents are fielding 68.5 events or calls a day. In order for the agents to reach the 96 calls a day average from the market report they would need spend an additional 3 hours or $30 per agent, if this $30 is multiplied by the number of agents then the client is losing that dollar amount per day, which can be used to determine the loss of profits, since the event change was implemented. Then sends the results from the Platform Data Analysis Module 112 to the Client Network 1-N 122, in some embodiments the Platform 102 may provide an interface to allow clients to view the results on the Platform 102 in real-time or in near real-time, element 116. The Platform Recommendation Module 118 is initiated by the Platform Base Module 104, continuously polls to receive data from the Platform Results Module 116, compares the received data to the Platform Recommendation Database 120, extracts the corresponding recommendation and sends the recommendation to the Client Network 122. For example, the data stored in Platform Analysis Results Database 114 may be the average difference in event time is an increase of 2 minutes, an increase of 1 minute, an increase of 3 minutes and an increase of 2.5 minutes, then the average for all of the agent's would be an increase of 2.125 minutes. The Platform Results Module 116 would determine the averages for each parameter for all of the agents, for example the averages for the average difference in the event time or duration of an event or call, the average difference in the agent's pace or words spoken per minute, the average difference in the client's pace or words spoken per minute, the average difference in the agent's average waveform frequency, the average difference in the client's average waveform frequency, the average difference in the agent's average decibel level, the average difference in the client's average decibel level, and the average difference in the customer rating and these averages would be sent to the Platform Recommendation Module 118 to be compared to the Platform Recommendation Database 120. For example, if the data received is the customer rating dropped by 0.75 on average for all of the call agents, the customer rating dropping on average 0.75 would be compared to the rules in the Platform Recommendation Database 120 and the database rules would be filtered on every rule that matches the average customer rating decreasing by 0.75, for example a rule in the Platform Recommendation Database 120 may be the average decrease in customer rating by 0.5-1. Another example may be if the received data was on average the agent's pace increased by 8 words per minute, the received data would be compared to the Platform Recommendation Database 120 and the database would be filtered to rules that match the received data, such as a rule of on average the call agent's pace increased by 5-10 words per minute. Once all of the averages are compared to the Platform Recommendation Database 120 to filter the database to the most relevant recommendation the recommendation is extracted, element 118. The Platform Recommendation Database 120 is used during the Platform Recommendation Module 118 and contains various rules and recommendations to allow the database to be filtered based on the data averages received from the Platform Results Module 116 to determine the relevant recommendations that should be sent to the Client Network 122. For example, the Platform Recommendation Module 118 receives data from the Platform Reporting Module 116 that is the averages of the data stored in the Platform Analysis Results Database 114 and those averages are compared to the Platform Recommendation Database 120 to filter the database to determine relevant recommendations that should be sent to the Client Network 122. The database contains a series of rules, such as rule 1, rule 2, and rule N to show an infinite number of rules that could be used in the database, and the recommendation that corresponds to the rules, element 120. The Client Network 1-N 122 are the various clients of the Platform that may have a subscription to the services offered by the platform, the Client Network 1-N 122 may be located on server, platform, or a scalable cloud environment, element 122. The Client Network 1-N Event Module 124 collects the audio data from the Client Network 1-N 122 and stores the data in the Client Network 1-N Source Database 126, determines if an event has occurred, for example a change in a work flow process such as a script adjustment for call agents, then stores the audio data in the Client Network 1-N Event Database 128, connects to the Platform Data Collection Module 106 and sends the Client Network 1-N Source Database 126 and the Client Network 1-N Event Database 128, element 124. The Client Network 1-N Source Database 126 contains the audio data of the Client Network 1-N 122 prior to an event, such as a change in a call agent's script, the database may contain agents performance, customer experience ratings, as well as audio data that can be used for behavioral analysis by the Platform 102, element 126. The Client Network 1-N Event Database 128 contains the audio data of the Client Network 1-N 122 after an event, such as a change in a call agent's script, the database may contain agents performance, customer experience ratings, as well as audio data that can be used for behavioral analysis by the Platform 102, element 128. The 3rd Party Market Data 130 may be market data that is relevant to a client's business or industry which can be collected through subscriptions or one-time payments through 3rd Party services such as Forrester, Gartner, Markets and Markets, Statista, etc., element 130.

Functioning of the Platform Base Module 104 will now be explained with reference to FIG. 2. The process begins with the Platform Base Module 104 initiating the Platform Data Collection Module 106, in which the Platform Data Collection Module 106 connects to the Client Network 1-N 122 to receive the Client Network 1-N Source Database 126 and the Client Network 1-N Event Database 128 and stores the data in the Platform Original Data Database 108 and the Platform Event Change Database 110, at step 200. Then the Platform Base Module 104 initiates the Platform Data Analysis Module 112 which performs an analysis to determine the average differences per agent from the Platform Original Data Database 108 and the Platform Event Change Database 110 and stores the resulting data in the Platform Analysis Result Database 114, at step 202. The Platform Base Module 104 initiates the Platform Results Module 116 which uses the data stored in the Platform Analysis Result Database 114 to determine the averages of the agent to determine if the change implemented had a positive or negative effect on the performance of the agents as a whole and then compares the results to the data collected from the 3rd Party Market Data 130 to determine the financial implications of the event change, at step 204. Then the Platform Base Module 104 initiates the Platform Recommendation Module 118 which uses the received data from the Platform Results Module 116 to be compared to the Platform Recommendation Database 120 to determine the relevant recommendations that should be sent to the Client Network 122, at step 206.

Functioning of the Platform Data Collection Module 106 will now be explained with reference to FIG. 3. The process begins with the Platform Data Collection Module 106 being initiated by the Platform Base Module 104, at step 300. Then the Platform Data Collection Module 106 connects to the Client Network 1-N 122, at step 302. The Platform Data Collection Module 106 sends a request to the Client Network 1-N Event Module 124 for the data stored in the Client Network 1-N Source Database 126 and the data stored in the Client Network 1-N Event Database 128, at step 304. The Platform Data Collection Module 106 receives the data stored in the Client Network 1-N Source Database 126 and the data stored in the Client Network 1-N Event Database from the Client Network 1-N Event Module 124, at step 306. Then the Platform Data Collection Module 106 stores the data from the Client Network 1-N Source Database 126 in the Platform Original Data Database 108 and stores the data from the Client Network 1-N Event Database 128 in the Platform Event Change Database 110, at step 308. Then the Platform Data Collection Module 106 returns to the Platform Base Module 104, at step 310.

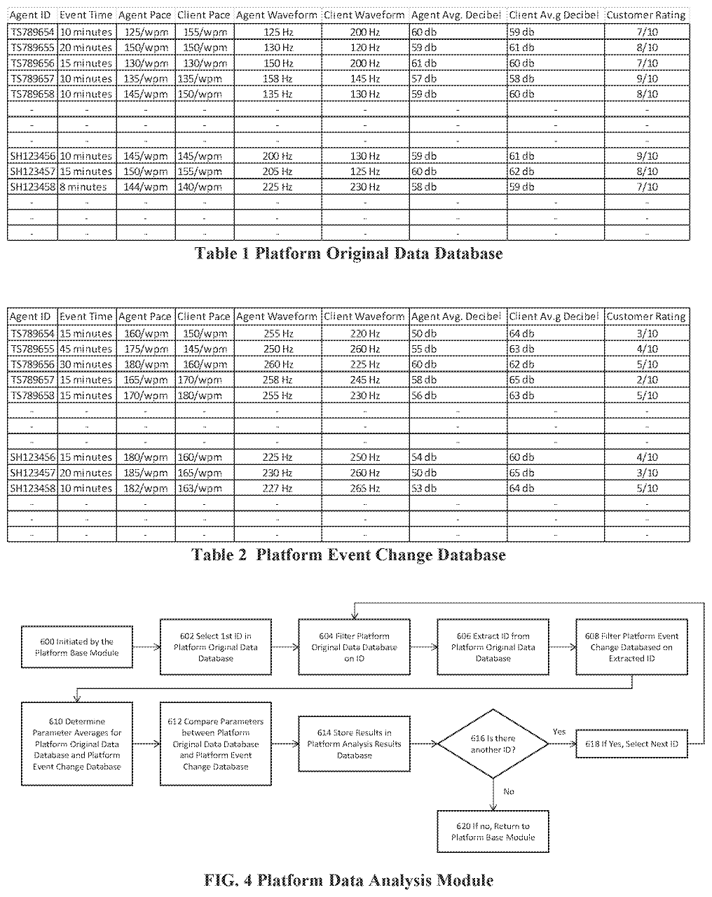

Functioning of the Platform Original Data Database 108 will now be explained with reference to FIG. 4. This figure displays the Platform Original Data Database 108 which is created through the process described in the Platform Data Collection Module 106 which collects the data from the Client Network 1-N Source Database 126 via the Client Network 1-N Event Module 124. The database contains the audio data for each agent for each event or call, such as the agent ID, the event time or duration of a call, the agent pace or words spoken per minute by the agent, the client's pace or the words spoken per minute by the client or customer, the agent waveform which is the average waveform frequency of the call agent, the client waveform which is the average waveform frequency of the client or customer, the agent average decibel or the average decibel level of the agent's voice during a call, the client average decibel level or the average decibel level of the client's or customer's voice during a call, and the customer rating or the rating from the customer based on the agent's performance during the event or call. For example, the agent's ID may be TS789654, the event time may be 10 minutes, the agent's pace may be 125 words per minute, the client's pace may be 155 words per minute, the agent's average waveform frequency may be 125 Hz, the client's average waveform frequency may be 200 Hz, the agent's average decibel level may be 60 decibels, the client's average decibel level may be 59 decibels, and the customer rating may be 7 out of 10. In some embodiments, the audio data may be collected by the Client Network 1-N Event Module 124 as a raw audio file or series of raw audio files and sent to the Platform 102 for the audio file or files to be analyzed to determine the metadata that results in these parameters described, element 400.

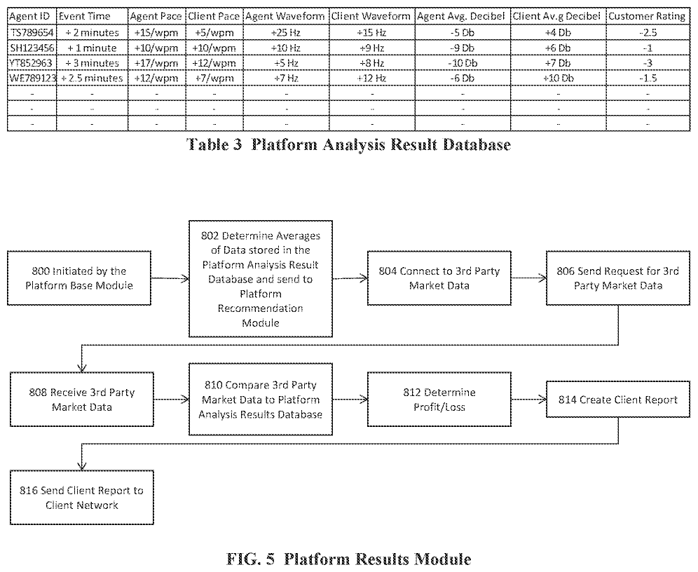

Functioning of the Platform Event Change Database 110 will now be explained with reference to FIG. 5. This figure displays the Platform Event Data Database 110 which is created through the process described in the Platform Data Collection Module 106 which collects the data from the Client Network 1-N Event Database 128 via the Client Network 1-N Event Module 124. The database contains the audio data for each agent for each event or call, such as the agent ID, the event time or duration of a call, the agent pace or words spoken per minute by the agent, the client's pace or the words spoken per minute by the client or customer, the agent waveform which is the average waveform frequency of the call agent, the client waveform which is the average waveform frequency of the client or customer, the agent average decibel or the average decibel level of the agent's voice during a call, the client average decibel level or the average decibel level of the client's or customer's voice during a call, and the customer rating or the rating from the customer based on the agent's performance during the event or call. For example, the agent's ID may be TS789654, the event time may be 15 minutes, the agent's pace may be 160 words per minute, the client's pace may be 150 words per minute, the agent's average waveform frequency may be 225 Hz, the client's average waveform frequency may be 220 Hz, the agent's average decibel level may be 50 decibels, the client's average decibel level may be 64 decibels, and the customer rating may be 3 out of 10. In some embodiments, the audio data may be collected by the Client Network 1-N Event Module 124 as a raw audio file or series of raw audio files and sent to the Platform Data Collection Module 1026 for the audio file or files to be analyzed to determine the metadata that results in these parameters described, element 500.

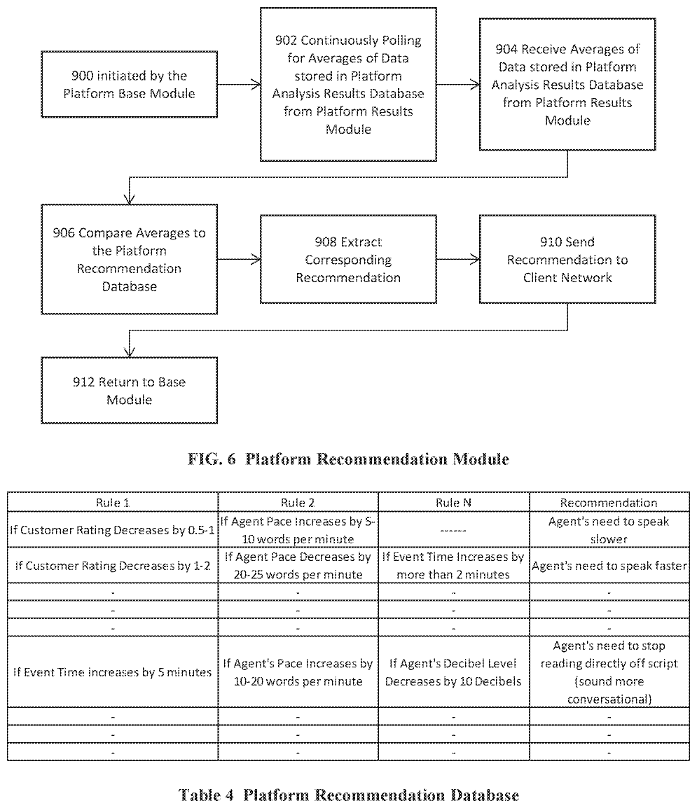

Functioning of the Platform Data Analysis Module 112 will now be explained with reference to FIG. 6. The process begins with the Platform Data Analysis Module 112 being initiated by the Platform Base Module 104, at step 600. The Platform Data Analysis Module 112 selects the first agent ID stored in the Platform Original Data Database 108, for example the Platform Data Analysis Module 112 selects the agent ID “TS789654” in the Platform Original Data Database 108, at step 602. Then the Platform Data Analysis Module 112 filters the Platform Original Data Database 108 on the agent ID, for example the Platform Data Analysis Module 112 filters the Platform Original Data Database 108 on the agent ID “TS789654”, at step 604. The Platform Data Analysis Module 112 extracts the agent ID from the Platform Original Data Database 108, for example the agent ID “TS789654” is extracted from the database, at step 606. Then the Platform Data Analysis Module 112 filters the Platform Event Change Database 110 on the extracted agent ID, for example the Platform Event Change Database 110 is filtered on the extracted agent ID “TS789654”, at step 608. Then the Platform Data Analysis Module 112 determines the parameter averages for the Platform Original Data Database 108 and the Platform Event Change Database 110, for example the Platform Data Analysis Module 112 determines the averages for the all the parameter data stored in the database based on the agent ID filter, the parameter data may be the time or duration of the event or call, the pace or words spoken per minute for the agent and the client, the average waveform frequency of the agent and the client, the average decibel level for the agent and the client, and the customer rating or the client rating of the agent for the event or call, at step 610. The Platform Data Analysis Module 112 compares the averages of the parameters between the Platform Original Data Database 108 and the Platform Event Change Database 110, for example the Platform Data Analysis Module 112 has previously determined the average parameters of the agent in step 610 for the data collected prior to an event change, the data stored in the Platform Original Data Database 108, and the data collected after an event change, the data stored in the Platform Event Change Database 110, and compares the total averages for each parameter, for example the averages of the time or duration of an event before and after an event change, the average words spoken per minute for the agent and the client before and after an event change, etc., at step 612. Then the Platform Data Analysis Module 112 stores the results of the comparison described in step 612 in the Platform Analysis Result Database 114, for example the data that would be stored would be the agent ID, the average change of time or duration of an event, the average difference in words spoken per minute for the agent and the client, the average difference in average waveform frequency for the agent and the client, the average difference in the average decibel level for the agent and the client, and the average difference in the customer or client rating of the agent during an event or call, at step 614. Then the Platform Data Analysis Module 112 determines if there is another agent ID in the Platform Original Data Database 108, at step 616. If there is another ID, the Platform Data Analysis Module 112 selects the next agent ID in the Platform Original Data Database 108 and returns to step 604, at step 618. If the Platform Data Analysis Module 112 determines that there are no more remaining agent IDs stored in the Platform Original Data Database 108 the Platform Data Analysis Module 112 returns to the Platform Base Module 104, at step 620.

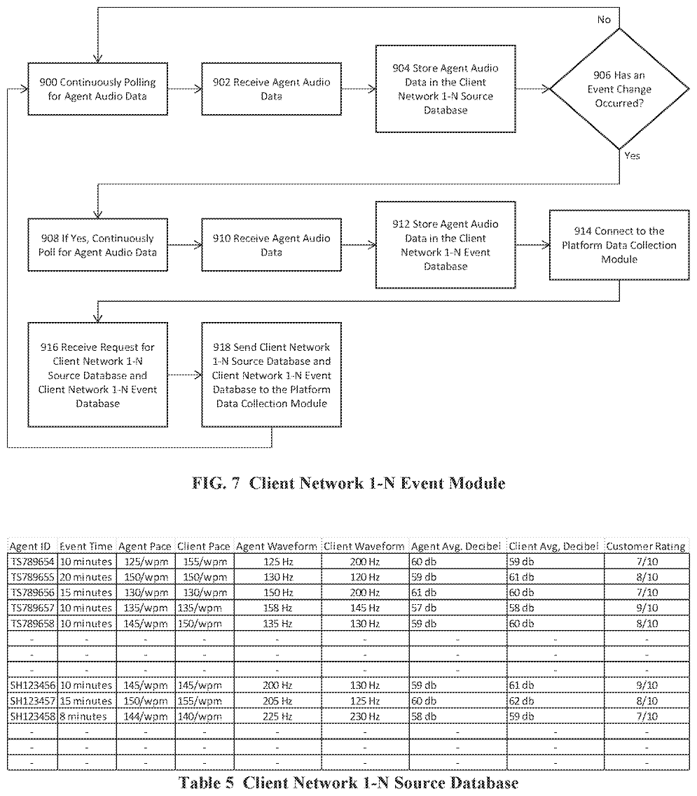

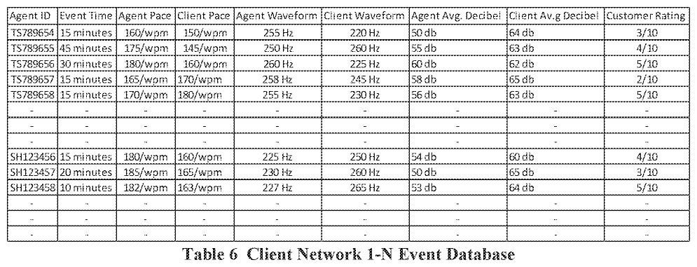

Functioning of the Platform Analysis Result Database 114 will now be explained with reference to FIG. 7. This figure displays the Platform Analysis Result Database 114 which stores the data from the analysis performed during the Platform Data Analysis Module 112 and is used during the process described in the Platform Results Module 116, the database contains the average difference in performance metrics for each agent from the Client Network 1-N 118 from the Platform Original Data Database 108 to the Platform Event Change Database 110. The database contains the various agent IDs, the average difference in the event time or duration of an event or call, the average difference in the agent's pace or words spoken per minute, the average difference in the client's pace or words spoken per minute, the average difference in the agent's average waveform frequency, the average difference in the client's average waveform frequency, the average difference in the agent's average decibel level, the average difference in the client's average decibel level, and the average difference in the customer rating. For example, the agent ID may be TS789654, with an average event time increased by two minutes, an increased average of agent's pace by 15 words spoken per minute, an increased average in client's pace by 5 words spoken per minute, an increased average of agent's average waveform frequency of 25 Hz, an increased average of client's average waveform frequency of 15 Hz, a decreased average in agent's average decibel level of 5 decibels, an increased average of client's average decibel level of 4 decibels, and a decreased average in customer rating of 2.5, element 700.

Functioning of the Platform Results Module 116 will now be explained with reference to FIG. 8. The process begins with the Platform Results Module 116 being initiated by the Platform Base Module 104, at step 800. Then the Platform Results Module 116 determines the averages for each of the parameters stored in the Platform Analysis Results Database 114, for example if the data stored in Platform Analysis Results Database for the average difference in event time is an increase of 2 minutes, an increase of 1 minute, an increase of 3 minutes and an increase of 2.5 minutes, the average for all of the agent's would be an increase of 2.125 minutes. The Platform Results Module 116 would determine the averages for each parameter for all of the agents, for example the averages for the average difference in the event time or duration of an event or call, the average difference in the agent's pace or words spoken per minute, the average difference in the client's pace or words spoken per minute, the average difference in the agent's average waveform frequency, the average difference in the client's average waveform frequency, the average difference in the agent's average decibel level, the average difference in the client's average decibel level, and the average difference in the customer rating. In some embodiments, the Platform Results Module 116 may determine the averages of the data for each parameter stored in the Platform Original Data Database 108 and the Platform Event Change Database 110, at step 802. Then the Platform Results Module 116 connects to the 3rd Party Market Data 130, for example market data such as reports, studies or analysis offered by companies such as Deloitte, Markets and Markets, Forrester, etc. at step 804. The Platform Results Module 116 sends a request for the 3rd Party Market Data 130, at step 806. Then the Platform Results Module 116 receives the 3rd Party Market Data 130, at step 808. The Platform Results Module 116 compares the 3rd Party Market Data 130 to the Platform Analysis Results Database 114, for example if the market data shows that the average event or call for an agent is 5 minutes and the averages stored in the Platform Analysis Result Database 114 show that there has been an increase in average event time, such as an increase of event time of 2.125 minutes, the Platform Results Module 116 can query the Platform Event Change Database 110 for the average event time to see if it is above or below the market data average of 5 minutes to determine if the event change, such as an adjustment to the agent's script, has made the agent's more or less efficient, at step 810. Then the Platform Results Module 116 determines the profit or loss for the event change that has taken place, for example if the received market data states that the average wage for an agent is $10 an hour and over the course of an 8 hour work day the agent fields 96 events or calls, an average of one call for every 5 minutes, the Platform Results Module 116 can use the averages determined from step 802 and the comparison from step 810 to determine if the agents have a similar average, for example if the average event time for the data stored in the Platform Event Change Database 110 is 7 minutes then since the event change the agents are fielding 68.5 events or calls a day. In order for the agents to reach the 96 calls a day average from the market report they would need spend an additional 3 hours or $30 per agent, if this $30 is multiplied by the number of agents then the client is losing that dollar amount per day since the event change was implemented. In some embodiments, there may be market data associated with the other parameters collected from the audio data such as customer experience which may be based on the customer rating given to an agent at the completion of an event or call. Another example may be the Platform Original Data Database 108 and Platform Event Change Database 110 may store the credits given to customers by the call agents when a customer returns a product, which can be compared in the process described in the Platform Data Analysis Module 112 to determine if the amount of credits offered by call agents increased or decreased after an event change and store the data in the Platform Analysis Result Database 114, and if there were more credits for returned products after the event change then the Platform Results Module 116 may determine a credit as a loss of profits, conversely if the amount of credits given to customers were to decrease from an event change the Platform Results Module 116 may determine that the savings on credits would be an increase in profits, at step 812. Then the Platform Results Module 116 creates a client report, for example the report may contain the dollar amount, such as how much money they are losing or saving, discussed in step 814, the average parameter data from the Platform Original Data Database 108, the average parameter data from the Platform Event Change Database 110, and the average differences from the Platform Analysis Result Database 114, which may include parameters such as the event time or duration of a call, the agent pace or words spoken per minute by the agent, the client's pace or the words spoken per minute by the client or customer, the agent waveform which is the average waveform frequency of the call agent, the client waveform which is the average waveform frequency of the client or customer, the agent average decibel or the average decibel level of the agent's voice during a call, the client average decibel level or the average decibel level of the client's or customer's voice during a call, and the customer rating or the rating from the customer based on the agent's performance during the event or call. This data in the report allows executives or a management team to review the effectiveness of the event change, such as a change in an agent's script, and how the agent's consistency in performance, changes in the agent's average performance, and changes in customer experience as well as a dollar amount or lump sum of the effect of the event change, at step 814. Then the Platform Results Module 116 sends the client report to the Client Network 1-N, in some embodiments the client report may be available on a GUI or guided user interface offered by the Platform 102 for clients, at step 816.

Functioning of the Platform Recommendation Module 118 will now be explained with reference to FIG. 9. The process begins with the Platform Base Module 104 initiating the Platform Recommendation Module 118, at step 900. The Platform Recommendation Module 118 is continuously polling to receive the averages of the data stored in the Platform Analysis Result Database 114 from the Platform Results Module 116. For example, the data stored in Platform Analysis Results Database 114 may be the average difference in event time is an increase of 2 minutes, an increase of 1 minute, an increase of 3 minutes and an increase of 2.5 minutes, then the average for all of the agent's would be an increase of 2.125 minutes. The Platform Results Module 116 would determine the averages for each parameter for all of the agents, for example the averages for the average difference in the event time or duration of an event or call, the average difference in the agent's pace or words spoken per minute, the average difference in the client's pace or words spoken per minute, the average difference in the agent's average waveform frequency, the average difference in the client's average waveform frequency, the average difference in the agent's average decibel level, the average difference in the client's average decibel level, and the average difference in the customer rating and these averages would be sent to the Platform Recommendation Module 118. In some embodiments, the Platform Results Module 116 may determine the averages of the data for each parameter stored in the Platform Original Data Database 108 and the Platform Event Change Database 110, at step 902. Then the Platform Recommendation Module 118 receives the averages of the data stored in the Platform Analysis Result Database 114 from the Platform Results Module 116, at step 904. The Platform Recommendation Module 118 then compares the received averages in of the data stored in the Platform Analysis Results Database 114 from the Platform Results Module 116 to the Platform Recommendation Database 120. For example, if the data received is the customer rating dropped by 0.75 on average for all of the call agents, the customer rating dropping on average 0.75 would be compared to the rules in the Platform Recommendation Database 120 and the database rules would be filtered on every rule that matches the average customer rating decreasing by 0.75, for example a rule in the Platform Recommendation Database 120 may be the average decrease in customer rating by 0.5-1. Another example may be if the received data was on average the agent's pace increased by 8 words per minute, the received data would be compared to the Platform Recommendation Database 120 and the database would be filtered to rules that match the received data, such as a rule of on average the call agent's pace increased by 5-10 words per minute. Once all of the averages are compared to the Platform Recommendation Database 120 to filter the database to the most relevant recommendation the recommendation is extracted, at step 906. The Platform Recommendation Platform 118 then extracts the corresponding recommendation from the Platform Recommendation Database 120 once the averages are compared to the database to filter the rules to determine the most relevant recommendation. For example, if the received data is the average customer rating decreased by 0.75 and the average agent's pace increased by 8 words per minute, the rules the database would be filtered on are the customer rating average decreases by 0.5-1, and the average agent's pace increased by 5-10 words per minute, the corresponding recommendation would be for the agents to speak slower and the recommendation would be extracted from the Platform Recommendation Database 120, at step 908. Then the Platform Recommendation Module 118 would send the extracted recommendation to the Client Network, which may be viewed by upper management, executives, managers, supervisors, etc., to provide the call agents with recommendations to improve the customers or clients interactions during events, at step 910. Then the Platform Recommendation Module 118 would return to the Platform Base Module 104, at step 912.

Functioning of the Platform Recommendation Database 120 will now be explained with reference to FIG. 10. This figure displays the Platform Recommendation Database 120 that is used during the process described in the Platform Recommendation Module 118 in which the Platform Recommendation Module 118 receives data from the Platform Reporting Module 116 that is the averages of the data stored in the Platform Analysis Results Database 114 and those averages are compared to the Platform Recommendation Database 120 to filter the database to determine relevant recommendations that should be sent to the Client Network 122. The database contains a series of rules, such as rule 1, rule 2, and rule N to show an infinite number of rules that could be used in the database, and the recommendation that corresponds to the rules. For example, the rules may be if the customer rating decreases by 1-2, if the agent pace decreases by 20-25 words per minute, and if the event time increases by more than two minutes with a corresponding recommendation of the agent's need to speak faster. If the received data was the customer rating decreased on average by 0.8, the agent's pace decreased on average by 22 words per minute, and the event time decreased on average by 2 minutes and 30 seconds, the database would be filtered on these previously discussed rules and the recommendation would be extracted and sent to the Client Network 122. In some embodiments, the Platform Recommendation Database 120 may be created by inputs from administrators of the Platform 102. In some embodiments, the database may use feedback from individual customers, clients or users of the services offered by the Platform. In some embodiments, the database may be updated by machine learning or artificial intelligence by storing the recommendations offered by the Platform 102 in a historical database and then after a predetermined amount of time, such as a week, month, quarter, etc., the historical recommendations may be compared to the Platform Analysis Results Database 114 to determine if the recommendations assisted in improving the call agents performance and efficiency. For example, using the example previously described with the recommendation being for the agent's to speak faster since the customer rating decreased on average by 0.8, the agent's pace decreased on average by 22 words per minute, and the event time decreased on average by 2 minutes and 30 seconds, the machine learning process may compare these averages to the new averages of the call agents since the recommendation was made. For example, the machine learning process could determine if the customer rating increased over that time period, if agent's pace increased and if the event time decreased it would be determined that the recommendation was useful to the call agents and the business. However, if it was determined that the recommendation was not useful, such as the averages worsened, there may be notification sent to the Platform 102 administrators or the users of the Client Network 122 to adjust the recommendation, element 1000.

Functioning of the Client Network 1-N Event Module 124 will now be explained with reference to FIG. 11. The process begins with the Client Network 1-N Event Module 124 continuously polling for the agent audio data, at step 1100. The Client Network 1-N Event Module 124 receives the agent audio data, at step 1102. The Client Network 1-N Event Module 124 stores the received agent audio data in the Client Network 1-N Source Database 126, at step 1104. Then the Client Network 1-N Event Module 124 determines if there has been an event change, such as a new script for call agents, in some embodiments the Client Network 1-N Event Module 124 may receive an input from a user, such as an admin user or executive, to determine when an event change has occurred, if there has been no event change then the process returns to step 1100 and continuously polls for the agent audio data, at step 1106. If it is determined that an event change has occurred then the Client Network 1-N Event Module 124 continuously polls for the agent audio data, at step 1108. The Client Network 1-N Event Module 124 receives the agent audio data, at step 1110. The Client Network 1-N Event Module 124 stores the received agent audio data in the Client Network 1-N Event Database 128, at step 1112. Then the Client Network 1-N Event Module 124 connects to the Platform Data Collection Module 112, at step 1114. The Client Network 1-N Event Module 124 receives a request from the Platform Data Collection Module 112 for the data stored in the Client Network 1-N Source Database 126 and the data stored in the Client Network 1-N Event Database 128, at step 1116. Then the Client Network 1-N Event Module 124 sends the data stored in the Client Network 1-N Source Database 126 and the data stored in the Client Network 1-N Event Database 128 to the Platform Data Collection Module 112, and the process returns to step 1100, at step 1118.

Functioning of the Client Network 1-N Source Database 126 will now be explained with reference to FIG. 12. This figure displays the Client Network 1-N Source Database 126 which is created through the process described in the Client Network 1-N Event Module 124, which collects call agent audio data prior to an event change, for example a change or alteration in the call agent's script, etc. The database contains the audio data for each agent for each event or call, such as the agent ID, the event time or duration of a call, the agent pace or words spoken per minute by the agent, the client's pace or the words spoken per minute by the client or customer, the agent waveform which is the average waveform frequency of the call agent, the client waveform which is the average waveform frequency of the client or customer, the agent average decibel or the average decibel level of the agent's voice during a call, the client average decibel level or the average decibel level of the client's or customer's voice during a call, and the customer rating or the rating from the customer based on the agent's performance during the event or call. For example, the agent's ID may be TS789654, the event time may be 10 minutes, the agent's pace may be 125 words per minute, the client's pace may be 155 words per minute, the agent's average waveform frequency may be 125 Hz, the client's average waveform frequency may be 200 Hz, the agent's average decibel level may be 60 decibels, the client's average decibel level may be 59 decibels, and the customer rating may be 7 out of 10. In some embodiments, the audio data may be collected by the Client Network 1-N Event Module 124 as a raw audio file or series of raw audio files and sent to the Platform 102 for the audio file or files to be analyzed to determine the metadata that results in these parameters described, element 1200.

Functioning of the Client Network 1-N Event Database 128 will now be explained with reference to FIG. 13. This figure displays the Client Network 1-N Event Database 128 which is created through the process described in the Client Network 1-N Event Module 124, which collects call agent audio data after an event change, for example a change or alteration in the call agent's script, etc. The database contains the audio data for each agent for each event or call, such as the agent ID, the event time or duration of a call, the agent pace or words spoken per minute by the agent, the client's pace or the words spoken per minute by the client or customer, the agent waveform which is the average waveform frequency of the call agent, the client waveform which is the average waveform frequency of the client or customer, the agent average decibel or the average decibel level of the agent's voice during a call, the client average decibel level or the average decibel level of the client's or customer's voice during a call, and the customer rating or the rating from the customer based on the agent's performance during the event or call. For example, the agent's ID may be TS789654, the event time may be 15 minutes, the agent's pace may be 160 words per minute, the client's pace may be 150 words per minute, the agent's average waveform frequency may be 225 Hz, the client's average waveform frequency may be 220 Hz, the agent's average decibel level may be 50 decibels, the client's average decibel level may be 64 decibels, and the customer rating may be 3 out of 10. In some embodiments, the audio data may be collected by the Client Network 1-N Event Module 124 as a raw audio file or series of raw audio files and sent to the Platform 102 for the audio file or files to be analyzed to determine the metadata that results in these parameters described, element 1300.

The present continuous value monitoring method for call center enterprises includes providing a data collection module, an original data database, an event change database, a data analysis module, an analysis results database, a client network, a results module including financial implications, and third party market data. The method further includes collecting audio data from a client network through the data collection module, storing the audio data in the original data database and event change database, analyzing and determining the differences from the original data database and event change database through the data analysis module, storing the differences in an analysis results database, receiving third party market data through the results module, comparing the analysis results database to the third party market data, determining the profit or loss for an enterprise through the results module, and creating a client report for the enterprise through the results module containing the profit or loss along with changes in performance metrics, performance consistency, and customer experience.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

What is claimed is:

1. A continuous value monitoring system comprising:
a platform including:
a base module,
a data collection module,
an original data database,
an event change database,
a data analysis module,
an analysis result database,
a results module,
a recommendation module, and
a recommendation database;
a client network communicatively coupled to the platform at a first network location, the client network including:
an event module,
a source database, and
an event database; and
third party market data accessible via the client network.

2. The system of claim 1, wherein the base module is configured to:
initiate the platform data collection module;
initiate the platform data analysis module;
initiate the platform results module; and
initiate the platform recommendation module.

3. The system of claim 1, wherein the after being initiated, the collection module is configured to:
connect to the client network;
send a request for data from the client network source database and the client network event database;
receive data from the client network source database and the client network event database;
store data in the platform original data database and the platform event change database; and
return focus to the platform base module.

4. The system of claim 1, after being initiated, the data analysis module is configured to:
select a first ID in the platform original data database;
filter the platform original data database on the first ID;
extract the first ID from the platform original data database;
filter the platform event change database on the extracted ID;
determine parameter averages for the platform original data database and the platform event change database;
compare parameters between the platform original data database and the platform event change database;
store the results of the comparing in the platform analysis results database; and
determine if there is another ID available; and
in the case there is not another ID available, return focus to the platform base module;
in the case there is another ID available, select the available ID and return to the step of filtering the platform original data database on the selected available ID, and proceed from there until there is not another ID available.

5. The system of claim 1, wherein after being initiated by the platform base module the results module is configured to:
determine averages of data stored in the platform analysis results database and send the averages to the platform recommendation module;
access the third party market data;
send a request for third party market data;
receive the third party market data;
compare the third part market data to analysis results data stored in the platform analysis results database;
determine a profit or loss based on the comparison;
create a client report; and
send the client report to the client network.

6. The system of claim 1, wherein after being initiated by the platform base module, the recommendation module is configured to:
continuously poll for averages of data stored in the platform analysis results database from the platform results module;
receive averages of data stored in the platform analysis results database from the platform results module;
compare averages to the platform recommendation database;
extract recommendations based on the comparison;
send the extracted recommendations to the client network; and
return focus to the platform base module.

7. The system of claim 1, wherein the client network 1-N event module is configured to:
continuously poll for agent audio data;
receive agent audio data;
store the received agent audio data in the client network 1-N source database; and
determine if an event change has occurred;
in the case an event change has not occurred, the client network 1-N event module returns to continuously poll for agent audio data, and continues from there;
in the case an event change has occurred, continuous polls for agent audio data;
receive agent audio data;
store the received agent audio data in the client network 1-N event database;
connect to the platform data collection module;
receive a request for the client network 1-N source database and client network 1-N source database;
send the client network 1-N source data base and client network 1-N event database to the platform data collection module; and
return focus to continuously poll for agent audio data and proceeding from there.

8. A continuous value monitoring method comprising:
obtaining a platform including:
a base module;
a data collection module;
an original data database;
an event change database;
a data analysis module;
an analysis result database;
a results module;
a recommendation module; and
a recommendation database;
communicatively coupling the platform to a client network 1-N at a first network location, the client network 1-N including:
an event module;
a source database; and
an event database; and
third party market data accessible via the client network.

9. The method of claim 8, wherein the base module performs the steps including:
initiating the data collection module;
initiating the data analysis module;
initiating the results module; and
initiating the recommendation module.

10. The method of claim 8, wherein the base module performs the steps including:
the data collection module performing steps after being initiated, including:
connecting to the client network 1-N;
sending a request for data from the client network source database and the client network event data base;
receiving data from the client network source database and the client network event database;
storing data in the original data database and the platform event change database; and
returning focus to the base module.

11. The method of claim 8, wherein after being initiated, the data analysis module performs the steps including:
selecting a first ID in the original data database;
filtering the original data database on the first ID;
extracting the first ID from the original data database;
filtering the platform event change database on the extracted ID;
determining parameter averages for the original data database and the platform event change database;
comparing parameters between the original data database and the platform event change database;
storing the results of the comparing in the platform analysis results database; and
determining if there is another ID available; and
in the case there is not another ID available, returning focus to the base module;
in the case there is another ID available, selecting the available ID and returning to the step of filtering the original data database on the selected available ID, and proceeding from there until there is not another ID available.

12. The method of claim 8, wherein after being initiated by the platform base module, the results module performs the steps including:
determining averages of data stored in the analysis results database and sending the averages to the recommendation module;
accessing the third party market data;
sending a request for third party market data;
receiving the third party market data;
comparing the third part market data to analysis results data stored in the analysis results database;
determining a profit or loss based on the comparison;
creating a client report; and
sending the client report to the client network.

13. The method of claim 8, wherein after being initiated by the platform base module, the recommendation module performs the steps including:
continuously polling for averages of data stored in the analysis results database from the platform results module;
receiving averages of data stored in the analysis results database from the platform results module;
comparing averages to the recommendation database;
extracting recommendations based on the comparison;
sending the extracted recommendations to the client network; and
returning focus to the base module.

14. The method of claim 8, wherein the client network 1-N event module performs the steps including:
continuously polling for agent audio data;
receiving agent audio data;
storing the received agent audio data in the client network 1-N source database; and
determining if an event change has occurred;
in the case an event change has not occurred, the client network 1-N event module returns to the step of continuously polling for agent audio data, and continues from there;
in the case an event change has occurred, continuous polling for agent audio data continues;
receiving agent audio data;
storing the received agent audio data in the client network 1-N event database;
connecting to the platform data collection module;
receiving a request for the client network 1-N source database and client network 1-N source database;
sending the client network 1-N source data base and client network 1-N event database to the platform data collection module; and
returning focus to the step of continuously polling for agent audio data and proceeding from there.
